(19) United States
(12) Patent Application Publication
(10) Pub. No.: US 2009/0139132 A1
(43) Pub. Date: Jun. 4, 2009

(54) Bait and accessory tray

(76) Inventor: Roy L. Knight, West Monroe, LA (US)

Correspondence Address: John M. Harrison, 2139 E. Bert Kouns, Shreveport, LA, 71105, US

(21) Appl. No.: 12/313,238

(22) Filed: Nov. 18, 2008

Related U.S. Application Data
(60) Provisional application No. 61/004,995, filed on Dec. 3, 2007.

(51) Int. Cl. A01K 97/06

(52) U.S. Cl. 43/54.1

(57) ABSTRACT

A bait and accessory tray for mounting in a fishing boat or watercraft, which in one embodiment includes a plate having an opening for receiving a bait container and a recess, typically adjacent to the opening, for receiving bait or particles or segments of bait to be used in fishing. One or more drain openings are typically provided in the bottom of the plate recess and a bracket bar is typically fitted with a pair of bolts secured to one edge of the plate for mounting the plate on a support in the watercraft. The support may also mount one or more fishing rod holders. In another embodiment the plate element of the tray is characterized by multiple bait container openings and a plate recess which is typically fitted with drain openings, for receiving bait of selected character. Like the single-opening bait tray, the multiple-opening tray may include a pair of bolts that mount a bracket bar on a pedestal or support in the watercraft to locate the trays in close proximity to the fisherman. One or more tool slots may also be provided in the tray plate for supporting various tools.

### CROSS-REFERENCE TO RELATED APPLICATIONS

This application claims the benefit of and incorporates by reference U.S. Provisional Application Ser. No. 61/004,995, Filed Dec. 3, 2007.

### SUMMARY OF THE INVENTION

Single and multiple opening bait and accessory trays for mounting in a fishing boat or watercraft are fitted with recesses for receiving live or artificial bait, or bait particles or segments and typically provided with drain openings for draining the plate recesses. The respective tray plates may have one or more openings of selected size and shape for receiving bait containers and one or more slots for receiving tools such as pliers and the like. A bracket bar is typically slip-fitted on a pair of bolts that span a pedestal or support in the watercraft, to typically removably and adjustably mount the trays on the support in close proximity to a fisherman. In one embodiment a single or multiple opening tray is mounted on a pedestal at a desired height, which pedestal is secured to the watercraft and also mounts one or more fishing rod mounts for receiving fishing rods.

### BRIEF DESCRIPTION OF THE DRAWINGS

The invention will be better understood by reference to the accompanying drawings, wherein:

FIG. 1 is a perspective view of a single opening bait and accessory tray embodiment of the invention mounted by means of a bracket bar assembly on a pedestal (illustrated in phantom) that supports multiple fishing rod holders (also illustrated in phantom) in a watercraft (not illustrated);

FIG. 2 is a top exploded view of the single opening bait and accessory tray and bracket bar assembly illustrated in FIG. 1, with the bait container and pliers removed, more particularly illustrating a typical mount bracket bar and bracket bar bolt assembly for removably and adjustably securing the single opening bait and accessory tray on the pedestal illustrated in FIG. 1;

FIG. 3 is a bottom view of the single opening bait and accessory tray and the mount bracket bar and bracket bar bolt assembly illustrated in FIG. 2;

FIG. 4 is a perspective view of a multiple opening bait and accessory tray, typically adapted for mounting on a support pedestal such as the pedestal fishing rod support illustrated in phantom in FIG. 1;

FIG. 5 is a top exploded view of the multiple opening bait and accessory tray and bracket bar assembly illustrated in FIG. 4 with the bait container and bait segments removed, more particularly illustrating typical bracket bar and bracket bar bolt components for removably and adjustably mounting the multiple opening bait and accessory tray on a pedestal or support in a watercraft (not illustrated); and

FIG. 6 is a bottom perspective view of the multiple opening bait and accessory tray and the mount bracket bar and bracket bar bolt assembly illustrated in FIG. 5.

### DESCRIPTION OF THE PREFERRED EMBODIMENTS

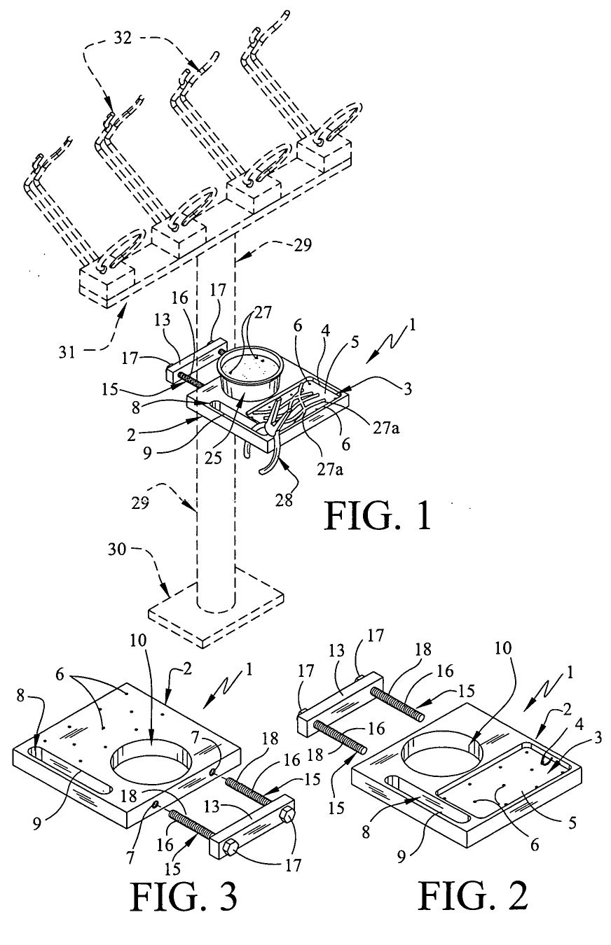

Referring now to FIGS. 1-3 of the drawings, in one embodiment of the invention a single opening bait and accessory tray is generally illustrated by reference numeral 1 and includes a single opening tray plate 2 of selected thickness and size, typically having a plate recess 3 of selected depth and size in the top thereof. The plate recess 3 is characterized by a recess rim 4 of selected depth and a recess bottom 5, which may typically include multiple, small drain openings 6 for allowing water or other liquid to drain from the plate recess 3. A quantity of bait segments 27a, which may be live worms or other live bait, as well as artificial bait such as plastic worms, jigs, flies and bait pellets or the like, which are formulated to attract fish, may be placed in the plate recess 3. Accordingly, the chosen bait is typically placed in the plate recess 3 on the recess bottom 5 for easy access by a fisherman (not illustrated), as further illustrated in FIG. 1. A bait container 25 is seated in a bait container opening 10 (FIGS. 2 and 3) in the single opening tray plate 2 and contains multiple bait particles or pellets 27 which, like the bait segments 27a illustrated in FIG. 1, may be removed from the bait container 25 or other packaging and placed on the recess bottom 5 of the plate recess 3, as desired. The bait container 25 can be quickly and easily removed from the bait container opening 10 in the single opening tray plate 2 and replaced therein, to maintain a supply of the bait particles 27, bait segments 27a and various selected combinations of live and artificial bait in close proximity to and in the plate recess 3.

In one embodiment of the invention a pair of spaced-apart, threaded bolt openings 7 are provided in one edge or side of the single opening tray plate 2 of the single opening bait and accessory tray 1, as illustrated in FIG. 3. The internally-threaded bolt openings 7 receive the bolt threads 18 of a pair of corresponding bracket bar bolts 15, each having a threaded bolt shank 16 terminated by a bolt head 17, as further illustrated in FIGS. 1-3 of the drawings. Furthermore, a bracket bar 13 is typically situated in close proximity to the single opening tray plate 2 adjacent to the threaded bolt opening 7 and is fitted with oversized openings at each end for receiving the threaded bolt shanks 16 of the respective bracket bar bolts 15, in a typically parallel, slip-fit relationship. Accordingly, the bolt threads 18 on the respective bolt shanks 16 can be threaded into the corresponding internally-threaded bolt openings 7 in the single opening tray plate 2, with the bracket bar 13 spanning a support such as the support pedestal 29 illustrated in phantom in FIG. 1. A pedestal base 30, also illustrated in phantom in FIG. 1, serves to mount the conventional support pedestal 29 in any convenient fashion on the side or bottom of a fishing boat or watercraft (not illustrated). One or a series of conventional fishing rod holders 32 may be mounted on a pedestal arm 31 attached to the top end of the support pedestal 29, as further illustrated in phantom in FIG. 1. Accordingly, it will be appreciated from a consideration of FIGS. 1-3 that the single opening bait and accessory tray 1 may be positioned in close proximity to a fisherman (not illustrated) near the fishing rod holders 32, which may each support a fishing rod (not illustrated), to facilitate periodically re-baiting of hooks (not illustrated) on the respective lines (not illustrated) of the fishing rods while fishing.

Referring again to FIGS. 1-3 of the drawings, a plate tool slot 8 may also be provided in the single opening tray plate 2 for receiving a tool or tools such as the pliers 28 (FIG. 1). The plate tool slot 8 typically has tool slot edges 9 of selected depth, typically extending through the thickness of the single opening tray plate 2, and the width of the plate tool slot 8 spanning the tool slot edges 9 is sized to accommodate substantially any tool, including the pliers 28. Accordingly, the plate tool slot 8 typically extends entirely through the thickness of the single opening plate 2, but may optionally only recess into the single opening plate 2 to a selected depth, depending on the selection of the tool or tools to be supported therein.

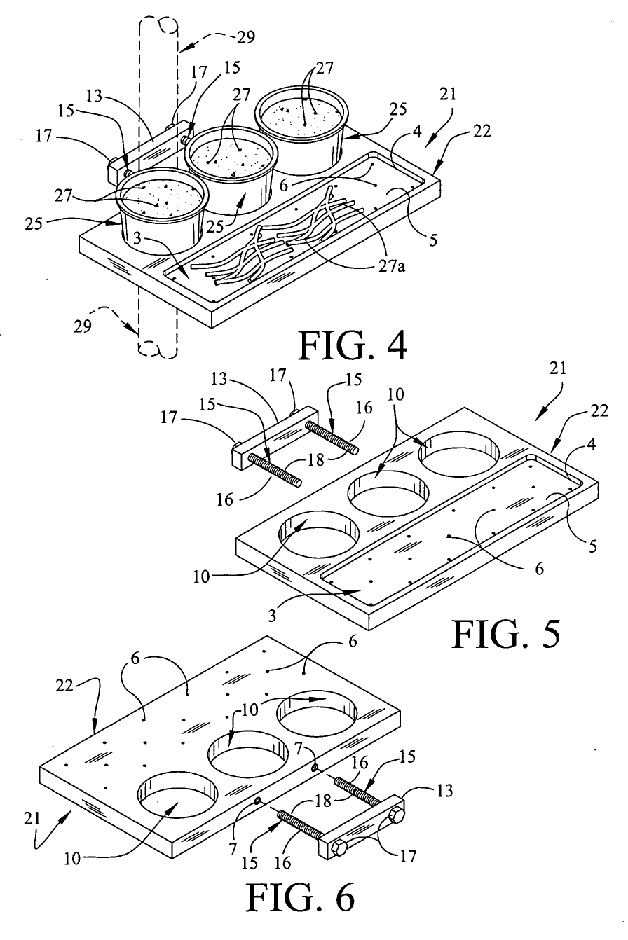

Referring now to FIGS. 4-6 of the drawings, in another embodiment of the invention a multiple opening bait and accessory tray 21 is illustrated and is characterized by a multiple opening tray plate 22 of selected size. The multiple opening tray plate 22 is typically characterized by three bait container openings 10, positioned adjacent to a plate recess 3 of selected depth and having a recess rim 4 of the selected depth, with a recess bottom 5 defined therein. Like the single opening tray plate 2 illustrated in FIGS. 1-3, the multiple opening tray plate 22 is typically characterized by multiple, small drain openings 6 for draining water or the like from the plate recess 3, since live or artificial bait, bait pellets or particles 27 (FIG. 4) and bait segments 27a and like bait may be deposited in the plate recess 3 to rest on the recess bottom 5, as further illustrated in FIG. 4 of the drawings. Accordingly, the supply of bait particles 27 or bait segments 27a provided in the three bait containers 25 located in the bait container openings 10, respectively, may be placed on the recess bottom 5 of the plate recess 3 for quick access by a fisherman in re-baiting a hook or hooks while fishing. It will be appreciated that a selected number of the bait container openings 10 may be provided in the multiple opening tray plate 22 of the multiple opening bait and accessory tray 21, depending upon the needs of the fisherman. Furthermore, it will be understood that the bait container openings 10 in both the single opening tray plate 2 and the multiple opening tray plate 22 can be of any selected size and may be typically designed to receive in a friction or slip-fit, the respective bait containers 25. Moreover, it is further understood that the bait container openings 10 may be of any selected shape, including a polygon or the like, in non-exclusive particular, to accommodate bait containers 25 of like shape. Furthermore, although the multiple opening tray plate 22 of the multiple opening bait and accessory tray 21 illustrated in FIGS. 4-6 does not have a plate tool slot 8 as illustrated in the single opening tray plate 2 of the single opening bait and accessory tray 1 illustrated in FIGS. 1-3, it will be appreciated that one or more plate tool slots 8 of selected size and depth may be provided in the multiple opening tray plate 22 to accommodate substantially any tool or tools, including, but not limited to, the pliers 28 illustrated in FIG. 1.

As in the case of the single opening bait and accessory tray 1 illustrated in FIGS. 1-3 of the drawings, a typical technique for mounting the multiple opening bait and accessory tray 21 on a pedestal such as the support pedestal 29 illustrated in phantom in FIG. 1, is the dual bracket bar bolts 15 and bracket bar 13 illustrated in FIGS. 4-6. Each of the bracket bolts 15 is characterized by a threaded bolt shank 16, typically slip-fitted in oversized holes (not illustrated) the bracket bar 13 and having a bolt head 17 at one end and bolt threads 18 for engaging correspondingly-spaced and internally-threaded bolt openings 7 in the multiple opening tray plate 22. This facilitates removable and adjustable securing of the multiple opening bait and accessory tray 21 on a support such as the support pedestal 29 illustrated in phantom in FIG. 1 of the drawings.

It will be further appreciated by those skilled in the art that the single opening tray plate 2 of the single opening bait and accessory tray 1 and the multiple opening tray plate 22 of the multiple opening bait and accessory tray 21 may be constructed in any size and thickness and of any selected material, such as aluminum, steel, fiberglass, plastic or the like, depending upon the desires of the user. Furthermore, one or more additional plate tool slots 8 of the same or different size, shape and/or depth as that illustrated in FIG. 1 of the drawings can be provided in the respective single opening tray plate 2 and multiple opening tray plate 22, further according to the desires of the user. Moreover, it will be recognized that the depth of the plate recess 3 and therefore, the size of the recess rim 4 in both the single opening tray plate 2 and multiple opening tray plate 22 can be varied, depending upon the nature and size of the bait segments 27a or particles 27 to be placed in the respective plate recesses.

While the preferred embodiments of the invention have been described above, it will be recognized and understood that various modifications may be made in the invention and the appended claims are intended to cover all such modifications which may fall within the spirit and scope of the invention.

Having described the invention with the particularity set forth above, what is claimed is:

1. A bait and accessory tray for mounting on a support in a watercraft,: comprising a plate; at least one bait container opening provided in said plate for removably receiving at least one bait container; at least one recess provided in said plate for receiving bait; and a plate support apparatus engaging said plate and the support in the watercraft for supporting said bait and accessory tray in the watercraft.

2. The bait and accessory tray of claim 1 comprising at least one drain opening provided in said recess for draining said recess.

3. The bait and accessory tray of claim 2 wherein said at least one drain opening comprises a plurality of drain openings provided in spaced-apart relationship with respect to each other in said recess.

4. The bait and accessory tray of claim 1 comprising at least one tool slot provided in said plate for receiving at least one tool.

5. The bait and accessory tray of claim 1 comprising:
(a) at least one drain opening provided in said recess for draining said recess; and
(b) at least one tool slot provided in said plate for receiving at least one tool.

6. The bait and accessory tray of claim 5 wherein said at least one drain opening comprises a plurality of drain openings provided in spaced-apart relationship with respect to each other in said recess.

7. The bait and accessory tray of claim 1 wherein said at least one bait container opening comprises a plurality of bait container openings provided in said plate.

8. The bait and accessory tray of claim 7 comprising at least one drain opening provided in said recess for draining water said recess.

9. The bait and accessory tray of claim 8 wherein said at least one drain opening comprises a plurality of drain openings provided in spaced-apart relationship with respect to each other in said recess.

10. The bait and accessory tray of claim 7 comprising at least one tool slot provided in said plate for receiving at least one tool.

11. The bait and accessory tray of claim 7 comprising:
(a) at least one drain opening provided in said recess for draining water from said recess; and
(b) at least one tool slot provided in said plate for receiving at least one tool.

12. The bait and accessory tray of claim 11 wherein said at least one drain opening comprises a plurality of drain openings provided in spaced-apart relationship with respect to each other in said recess.

13. A bait and accessory tray for mounting on a support in a fishing boat comprising a plate of selected size; at least one bait container opening having a selected size and shape provided in said plate; at least one recess having a selected depth and size and a recess bottom, provided in said plate; and a bracket and bolt assembly adjustably engaging said plate and the support in the fishing boat for locating said bait and accessory tray in a selected position in the fishing boat.

14. The bait and accessory tray of claim 13 comprising at least one drain opening provided in said recess bottom of said recess for draining said recess.

15. The bait and accessory tray of claim 14 wherein said at least one drain opening comprises a plurality of drain openings provided in spaced-apart relationship with respect to each other in said recess bottom.

16. The bait and accessory tray of claim 13 comprising at least one tool slot provided in said plate for receiving at least one tool.

17. The bait and accessory tray of claim 13 comprising:
(a) at least one drain opening provided in said recess bottom of said recess for draining said recess; and
(b) at least one tool slot provided in said plate for receiving at least one tool.

18. The bait and accessory tray of claim 17 wherein said at least one drain opening comprises a plurality of drain openings provided in spaced-apart relationship with respect to each other in said recess bottom.

19. A bait and accessory tray for mounting on a support in a fishing craft comprising a plate of selected size; a plurality of bait container openings having a selected size and shape provided in said plate; at least one recess having a selected depth and size and a recess bottom, provided in said plate; and a bracket and bolt assembly removably and adjustably engaging said plate and the support in the watercraft for locating said bait and accessory tray in a selected position on the support in the watercraft.

20. The bait and accessory tray of claim 19 comprising a plurality of drain openings provided in said recess bottom of said recess for draining said recess and at least one tool slot provided in said plate for receiving at least one tool.
